(19) United States
(12) Patent Application Publication
(10) Pub. No.: US 2008/0259610 A1
(43) Pub. Date: Oct. 23, 2008

(54) Structure and manufacturing method for fluorescent paster

(76) Inventor: Yuan Lin, Taipei City (TW)

Correspondence Address: TROXELL LAW OFFICE PLLC;SUITE 1404, 5205 LEESBURG PIKE, FALLS CHURCH, VA, 22041, US

(21) Appl. No.: 11/882,079

(22) Filed: Jul. 30, 2007

(30) Foreign Application Priority Data
Apr. 18, 2007 (TW) 096113591

(51) Int. Cl. F21V 3/00; B05D 5/06; F21V 21/00

(52) U.S. Cl. 362/311; 427/67; 362/368

(57) ABSTRACT

A fluorescent paster generally comprises a light-pervious layer, a fluorescent power layer, a bottom layer and an adhesive layer. The light-pervious layer is mounted in a topmost position to emit a light beam. The fluorescent power layer is mounted under the light-pervious layer to change the color of the light beam when the light beam passes through the fluorescent power layer. The bottom layer is mounted under the fluorescent power layer. The adhesive layer is mounted under the bottom layer. As a result, the color of the light is changeable by means of the fluorescent power layer and the fluorescent paster is attachable to an article by means of the adhesive layer.

### FIELD OF THE INVENTION

The present invention relates to a structure and a manufacturing method for a fluorescent paster, and more particularly to a fluorescent paster that contains a fluorescent power added therein to change the color of the light and is attachable to a lighting body such as a lamp bulb, a light-emitting diode, a lighting lamp bar or the like.

### BACKGROUND OF THE INVENTION

The invention of lamp bulbs that replace the earlier kerosene lamps changes human lives. With the process of high technologies, light-emitting diodes are invented, wherein the light-emitting diodes are capable of substituting for the lamp bulbs gradually so many high-tech companies are very zealous to develop related products.

For all existing light-emitting diodes, a junction is formed between a p-type semiconductor and an n-type semiconductor. If these two semiconductors are of the same material, this junction is called as a homojunction. If these two semiconductors are of different materials, this junction is called as a heterojunction. The heterojunction structure is generally utilized to increase the recombination probability of electrons and holes so that the energy gap of the middle light-emitting layer is smaller than that of the bilateral cladding layers. The heterojunction is such as AlGaN/GaN, GaInN/GaN or AlGaN/GaInN heterojunction.

The above-mentioned light-emitting diode can be made of a single material or a mixture of materials to obtain a required light color. However, other required light color can not be obtained without manufacturing another light-emitting diode. At present, more and more locations and articles require many different light colors, but it is impossible to replace the light-emitting diode frequently to provide different light colors. Moreover, it is not easy to perform the replacement, which causes the increase of cost, resulting in the inconvenience.

In view of this, the present inventor makes diligent studies in providing the general public with a structure and a manufacturing method for a fluorescent paster to save manufacturing cost and save time in replacement so as to change the light color easily and increase the intensity of lighting.

### SUMMARY OF THE INVENTION

It is an object of the present invention to provide a structure and a manufacturing method for a fluorescent paster, wherein the fluorescent paster contains a fluorescent power added therein to change the color of the light for providing the convenience in use.

It is another object of the present invention to provide a structure and a manufacturing method for a fluorescent paster, wherein the fluorescent paster is attachable to any lighting body for providing practicability in use.

It is a further object of the present invention to provide a structure and a manufacturing method for a fluorescent paster that changes the light color by modifying the ingredient of the fluorescent power contained in the fluorescent power layer to be suitable for use in different products.

In order to achieve the foregoing objects, a fluorescent paster generally comprises a light-pervious layer, a fluorescent power layer, a bottom layer and an adhesive layer. The light-pervious layer is mounted in a topmost position to emit a light beam. The fluorescent power layer is mounted under the light-pervious layer to change the color of the light beam when the light beam passes through the fluorescent power layer. The bottom layer is mounted under the fluorescent power layer. The adhesive layer is mounted under the bottom layer. As a result, the color of the light is changeable by means of the fluorescent power layer and the fluorescent paster is attachable to an article by means of the adhesive layer.

Accordingly, the fluorescent paster contains a fluorescent power added therein to change the color of the light for providing the convenience in use.

The aforementioned and other objects and advantages of the present invention will be readily clarified in the description of the preferred embodiments and the enclosed drawings of the present invention.

### BRIEF DESCRIPTION OF THE DRAWINGS

FIG. 1 is an elevational view showing a fluorescent paster of the present invention.

FIG. 2 is a schematic view showing the fluorescent paster of the present invention.

FIG. 3 is a process diagram illustrating the manufacturing process of the fluorescent paster of the present invention.

FIG. 4 is a first embodying example of the fluorescent paster of the present invention.

FIG. 5 is a second embodying example of the fluorescent paster of the present invention.

### DETAILED DESCRIPTION OF THE PREFERRED EMBODIMENT

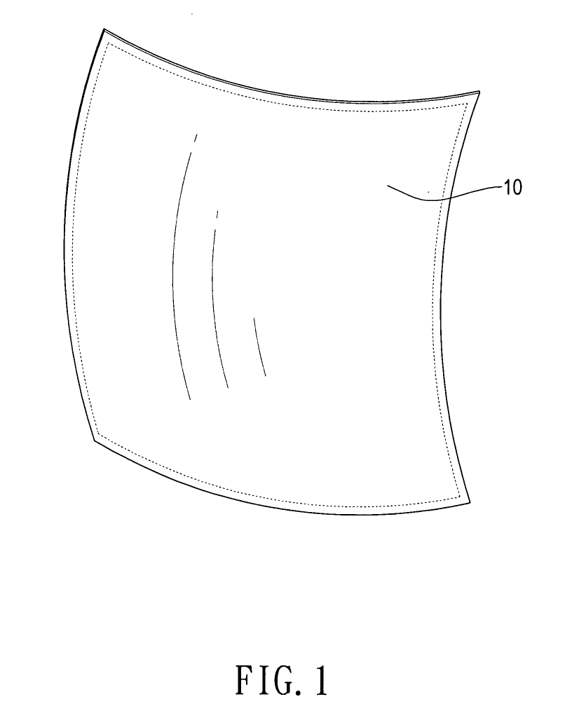

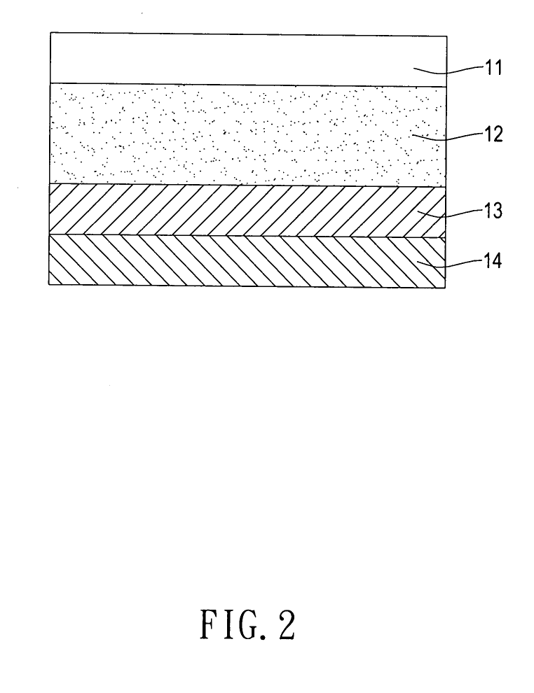

Referring to FIGS. 1 and 2, a fluorescent paster 10 of the present invention comprises a light-pervious layer 11, a fluorescent power layer 12, a bottom layer 13 and an adhesive layer 14. The light-pervious layer 11 is a resin and locates in a topmost position to emit light beams. The fluorescent power layer 12 is located under the light-pervious layer 11. The fluorescent power of the fluorescent power layer 12 contains yttrium aluminum garnet or terbium aluminum garnet. Alternatively, the fluorescent power may contain at least one material selected from the group consisting of magnesium tungstate, calcium tungstate, zinc silicate, lanthanum oxyfluoride and zinc sulfide or may contain at least one material selected from the group consisting of calcium, strontium, barium, zinc, cadmium, mercury, sulfur, selenium, manganese, copper, sliver, europium and terbium. Accordingly, the color of the light can be changed by the fluorescent power after the light beams pass through the fluorescent power layer 12. The bottom layer 13 is located under the fluorescent power layer 12. The bottom layer 13 is made of a plastic material such as polyvinylchloride (PVC) or a transparent thin film made of paper or glass to be pervious to the light. The adhesive layer 14 is mounted under the bottom layer 13. The adhesive layer 14 is a glue layer made of an adhesive material to be stuck on any article.

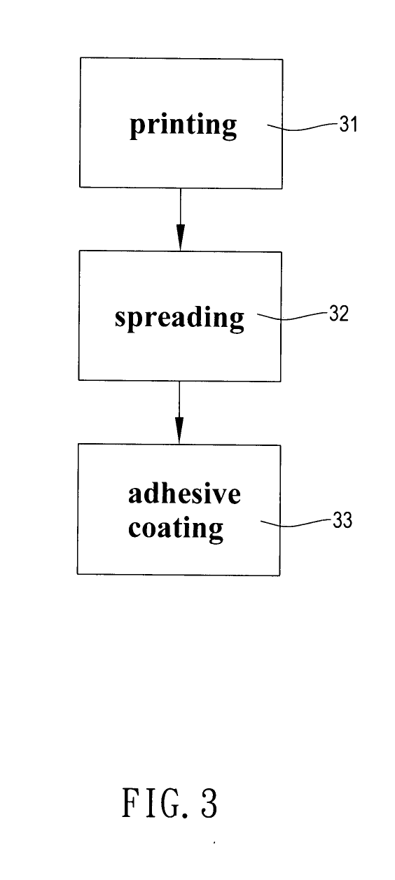

Referring to FIG. 3, a process diagram illustrating the manufacturing process of the fluorescent paster of the present invention is shown. The manufacturing process comprises: a printing step 31 for printing a fluorescent power on one side of a bottom paper layer so as to form a fluorescent power layer; a spreading step 32 for spreading a transparent material on the fluorescent power layer to form a light-pervious layer on the fluorescent power layer; and an adhesive coating step 33 for coating an adhesive layer on the other side of the bottom layer, thereby completing the manufacture process of the fluorescent paster.

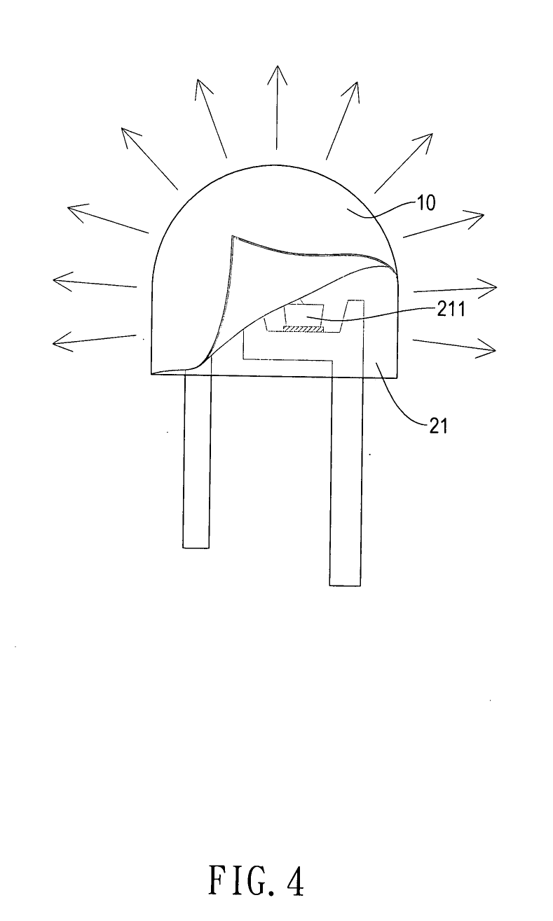

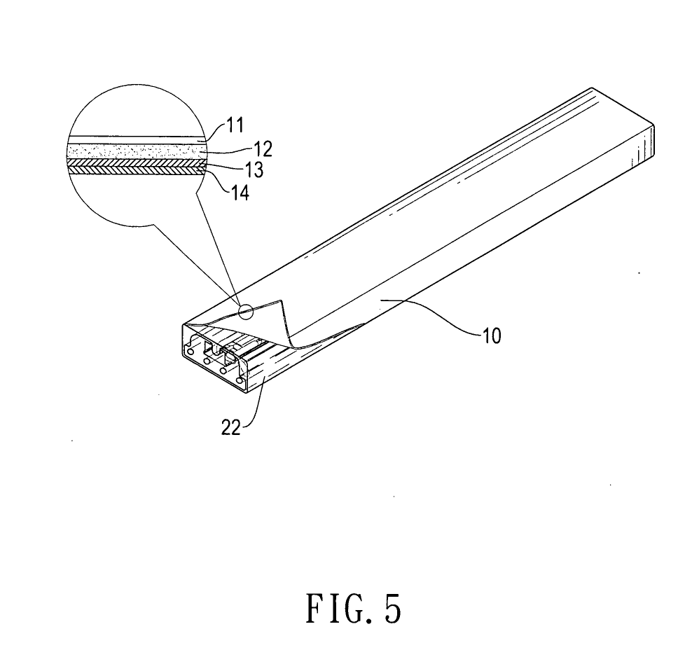

Referring to FIGS. 4 and 5, two embodying examples of the present invention are shown. The fluorescent paster is capable of changing the color of the light by means of the fluorescent power contained therein. The fluorescent power contains yttrium aluminum garnet or terbium aluminum garnet. Alternatively, the fluorescent power may contain at least one material selected from the group consisting of magnesium tungstate, calcium tungstate, zinc silicate, lanthanum oxyfluoride and zinc sulfide or may contain at least one material selected from the group consisting of calcium, strontium, barium, zinc, cadmium, mercury, sulfur, selenium, manganese, copper, sliver, europium, terbium, and any mixture thereof. As a result, the fluorescent power may contain different ingredients so as to change the light beams into different colors. For example, the yttrium aluminum garnet can change the blue color of the light emitted from the light-emitting device into the white color. Further, for example, the yttrium aluminum garnet doped with terbium is green, the tin oxide doped with europium is red, the yttrium aluminum garnet doped with europium is red, the yttrium oxide doped with europium is pink, the zinc sulfide doped with manganese is orange-yellow, and the zinc sulfide doped with terbium and fluorine is orange-yellow. In this preferred embodiment, the fluorescent power may contain different ingredients so as to change the light beams emitted from the light-emitting device into different colors. In addition, the adhesive layer is formed on one side of the fluorescent paster 10, wherein the adhesive layer can be made of different materials so as to adjust the amount of the adhesive material and the viscosity of the adhesive layer so that the fluorescent paster 10 is attachable to the article. As shown in FIG. 4 and FIG. 5, the fluorescent paster 10 is stuck on an existing light-emitting diode 21 so as to change the color of the light emitted from a chip 211 and change the intensity of lighting. The fluorescent paster 10 comprises a light-pervious layer 11, a fluorescent power layer 12, a bottom layer 13 and an adhesive layer 14, wherein the light-pervious layer 11 is a resin, epoxy resin, polypropylene, polyethylene or polystyrene and locates in a topmost position to emit light beams. The epoxy resin is generally cured by reaction with acid anhydride, wherein a major agent and a curing agent must be uniformly mixed before use. The major agent comprises epoxy oligomer, viscosity-adjusting agent, coloring agent, etc. The curing agent comprises acid anhydride and catalyst/curing accelerator. The physical property of the cured epoxy resin is changeable by the change in the ratio of major agent to curing agent. It is generally prepared by using an equivalent ratio of 1:1 to obtain most proper property. The fluorescent power layer 12 is located under the light-pervious layer 11 so that the fluorescent power layer 12 can change the color of the light when the light passes through the fluorescent power layer 12. The bottom layer 13 is located under the fluorescent power layer 12. The bottom layer 13 is made of a plastic material such as polyvinylchloride (PVC) or a transparent thin film made of paper or glass to be pervious to the light. The adhesive layer 14 is mounted on one side of the bottom layer 13. The adhesive layer 14 is a glue layer made of an adhesive material to be stuck on a lighting lamp bar 22 so that the light color of the lighting lamp bar 22 is diversely changeable to beautify appearance.

From the foregoing description, the structure and the manufacturing method of the present invention have the following advantages:

1. Various light colors are obtainable by combining the fluorescent power with the fluorescent paster so that the production cost and the manufacturing cost can be reduced.

2. The fluorescent paster can be widely applied to the light-emitting device, thereby increasing the convenience and practicability in use.

To sum up, the present invention is capable of achieving the aforementioned objects. Therefore, this application is filed according to the patent law.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A fluorescent paster, comprising:
a light-pervious layer mounted in a topmost position to emit a light beam;
a fluorescent power layer mounted under said light-pervious layer to change the color of said light beam by means of a fluorescent power contained therein when said light beam passes through said fluorescent power layer;
a bottom layer mounted under said fluorescent power layer; and
an adhesive layer mounted under said bottom layer, whereby the color of said light beam is changeable by means of said fluorescent power layer and said fluorescent paster is attachable to an article by means of said adhesive layer.

2. A fluorescent paster according to claim 1, wherein said fluorescent power of said fluorescent power layer contains yttrium aluminum garnet.

3. A fluorescent paster according to claim 1, wherein said fluorescent power of said fluorescent power layer contains terbium aluminum garnet.

4. A fluorescent paster according to claim 1, wherein said fluorescent power of said fluorescent power layer contains at least one material selected from the group consisting of magnesium tungstate, calcium tungstate, zinc silicate, lanthanum oxyfluoride and zinc sulfide.

5. A fluorescent paster according to claim 1, wherein said fluorescent power of said fluorescent power layer contains at least one material selected from the group consisting of calcium, strontium, barium, zinc, cadmium, mercury, sulfur, selenium, manganese, copper, sliver, europium and terbium.

6. A fluorescent paster according to claim 1, wherein said bottom layer is made of a plastic material.

7. A fluorescent paster according to claim 1, wherein said light-pervious layer is a resin.

8. A fluorescent paster according to claim 1, wherein said light-pervious layer is an epoxy resin.

9. A fluorescent paster according to claim 1, wherein said light-pervious layer is selected from the group consisting of polypropylene, polyethylene and polystyrene.

10. A fluorescent paster according to claim 1, wherein said adhesive layer is a glue layer made of an adhesive material.

11. A method of manufacturing a fluorescent paster, comprising the steps of:
performing a printing step for printing a fluorescent power on one side of a bottom layer so as to form a fluorescent power layer;
performing a spreading step for spreading a transparent material on said fluorescent power layer to form a light-pervious layer on said fluorescent power layer; and
performing an adhesive coating step for coating an adhesive layer on the other side of said bottom layer.

12. A method of manufacturing a fluorescent paster according to claim 11, wherein said fluorescent power of said fluorescent power layer contains yttrium aluminum garnet.

13. A method of manufacturing a fluorescent paster according to claim 11, wherein said fluorescent power of said fluorescent power layer contains terbium aluminum garnet.

14. A method of manufacturing a fluorescent paster according to claim 11, wherein said fluorescent power contains at least one material selected from the group consisting of magnesium tungstate, calcium tungstate, zinc silicate, lanthanum oxyfluoride and zinc sulfide.

15. A method of manufacturing a fluorescent paster according to claim 11, wherein said fluorescent power contains at least one material selected from the group consisting of calcium, strontium, barium, zinc, cadmium, mercury, sulfur, selenium, manganese, copper, sliver, europium and terbium.

16. A method of manufacturing a fluorescent paster according to claim 11, wherein said bottom layer is made of a plastic material.

17. A method of manufacturing a fluorescent paster according to claim 11, wherein said light-pervious layer is a resin.

18. A method of manufacturing a fluorescent paster according to claim 11, wherein said light-pervious layer is an epoxy resin.

19. A method of manufacturing a fluorescent paster according to claim 11, wherein said light-pervious layer is selected from the group consisting of polypropylene, polyethylene and polystyrene.

20. A method of manufacturing a fluorescent paster according to claim 11, wherein said adhesive layer is a glue layer made of an adhesive material.
